(19) United States
(12) Patent Application Publication
(10) Pub. No.: US 2025/0267382 A1
(43) Pub. Date: Aug. 21, 2025

(54) TWEETER BOX WITH MINIMIZED DIMENSIONS AND IMPROVED THERMAL CHARACTERISTICS

(71) Applicant: DELL PRODUCTS L.P., Round Rock, TX (US)

(72) Inventors: Chien-Yu Huang, New Taipei City (TW); Cola Hung Shih, Taipei (TW)

(21) Appl. No.: 18/582,145

(22) Filed: Feb. 20, 2024

(51) Int. Cl. H04R 1/02; H04R 1/22; H04R 7/04; H04R 9/02; H04R 9/04

(52) U.S. Cl. CPC H04R 1/025; H04R 1/22; H04R 9/022; H04R 9/025; H04R 7/04; H04R 9/045; H04R 2499/11

(57) ABSTRACT

A speaker is provided for a mobile device. The speaker includes a bottom cover formed of a first metallic material and a top cover is formed of a second metallic material. A diaphragm is affixed to the top cover, and the top cover is sealed to the bottom cover.

### FIELD OF THE DISCLOSURE

This disclosure generally relates to information handling systems, and more particularly relates to a tweeter boxes with minimized dimensions and improved thermal characteristics in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A speaker may be provided for a mobile device. The speaker may include a bottom cover, a sound producing diaphragm, and a top cover. The bottom cover may be formed of a first metallic material. The top cover may be formed of a second metallic material. The diaphragm may be affixed to the top cover. The top cover may be sealed to the bottom cover.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIGS. 1A-C are various views of an iron-shell speaker according to an embodiment of the present disclosure; and

FIG. 2 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

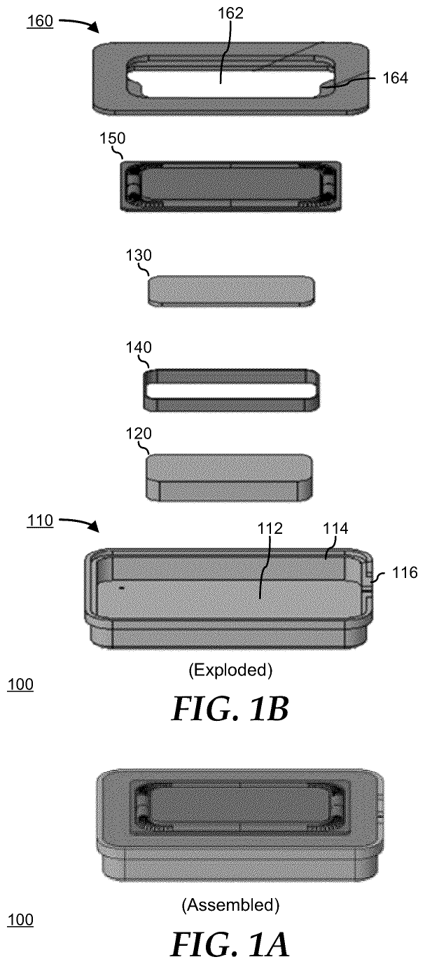

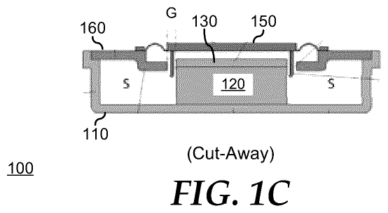

FIG. 1A illustrates an iron-shell speaker 100, FIG. 1B illustrates an exploded view of the iron-shell speaker, and FIG. 1C illustrates a cut-away view of the iron-shell speaker. Speaker 100 may represent a speaker adapted to use in information handling system, and particularly in laptop computers, mobile devices, or the like. Such speakers operate in an environment where space and power are constrained, while the expectations for sound quality are high. Speaker 100 may be particularly adaptable for use as a tweeter, that is, a high-frequency range speaker that is typically located on a front panel of the information handling system. For example, speaker 100 may represent one of a pair of tweeter speakers in a laptop computer that are located in a case of the laptop computer, between the edges of the case and a keyboard. Such speakers typically make trade-offs between the volume of the speaker enclosure and the acoustic performance of the speaker. Further, such speakers may generate excessive heat when operating at high volume levels, due to the small size of the components. In particular, if the temperature of the permanent magnet of the speaker is higher than the Curie point, the magnet may become demagnetized, resulting in the failure of the speaker.

Speaker 100 includes a combined yoke/lower cover 110 (hereinafter “yoke 110”), a permanent magnet 120, an internal washer 130, a voice coil 140, a diaphragm 150, and a combined external washer/upper cover 160 (hereinafter “washer element 160”). Yoke 110 represents a base element for speaker 100 that conducts the magnetic fields in the speaker when voice coil 130 is energized. Yoke 110 combines the functions of a typical speaker yoke with a lower cover, or enclosure for the speaker. In this regard, the typical speaker may include separate elements, such as an enclosure that may be formed in the case of the computer, into which the speaker is installed. In such cases, the yoke represents the bottom element of the speaker. However by combining the lower cover element of the typical speaker with the yoke of the typical speaker into a single element (that is, yoke 110), speaker 100 may exhibit a lower profile than a typical speaker with similar performance, as described further below.

Yoke 110 includes a bottom plate 112, sidewalls 114, and a mounting lip 116. Bottom plate 112 represents the bottom portion of yoke 110, and also acts as the bottom of the enclosure for speaker 100, with sidewalls 114 acting as the vertical element of the enclosure. Mounting lip 116 provides a mounting surface for the upper elements of speaker 100, as described further below. Yoke 110 may be fabricated of a magnetically conductive material, such as iron, cobalt, or the like. Magnet 120 is affixed to the top side of bottom plate 112, and internal washer 140 is affixed to the top side of the magnet. Magnet 120 may represent a rare-earth magnet, such as a neodymium magnet or the like, as needed or desired. Internal washer 130 may be fabricated of a magnetically conductive material, such as iron, cobalt, or the like. Yoke 110, magnet 120, and internal washer 130 are formed as a bottom assembly to which the other elements of speaker 100 are attached, as described below.

A top assembly of speaker 100 includes voice coil 140, diaphragm 150, and washer element 160. In particular, washer assembly 160 includes an opening 162 with a diaphragm mounting rim 164. Opening 162 is sized to correspond with the size of diaphragm 150, and the diaphragm is flexibly affixed to diaphragm mounting rim 164. For example, the edges of diaphragm 150 may be glued to diaphragm mounting rim 164, or otherwise affixed, as needed or desired. voice coil 140 is affixed to the bottom side of diaphragm 150. The top assembly (that is, voice coil 140, diaphragm 160, and washer element 160) is affixed to the bottom assembly to complete the assembly of speaker 100. In particular, washer assembly 160 may be glued to mounting lip 116, or otherwise affixed, as needed or desired. Voice coil 140 is sized to fit around magnet 120, and to include electrical leads to receive a sound signal to vibrate diaphragm 150 to create sound. The details of creating sound in a speaker, and particularly of the design an implementation of permanent magnets, speaker coils, diaphragms, and the like, are known in the art and will not be further described herein, except as may be needed to illustrate the current embodiments.

Washer element 160 combines the functions of a typical speaker basket with a top cover for the speaker. In this regard, the typical speaker may include a separate speaker basket and a separate top cover. However by combining the speaker basket element of the typical speaker and the top cover of the speaker into a single element (that is, washer element 160), speaker 100 may exhibit an even lower profile than a typical speaker with similar performance, as described further below. Washer assembly 160 may be fabricated of a magnetically conductive material, such as iron, cobalt, or the like. Yoke 110, magnet 120, washer 130, and washer element 160, together form the fixed or rigid elements of speaker 100, while voice coil 140 and diaphragm 150 form the moveable, or sound producing elements of the speaker.

It has been understood by the inventors of the current disclosure that speaker 100 provides several advantages over the typical tweeter speaker for a laptop computer or the like. in particular, speaker 100 provides a smaller dimensional volume over the typical tweeter. For example, the inventors have determined that a typical tweeter may have a diaphragm area of 16 mm*9 mm (144 mm²) and have a total surface footprint of 21 mm*14 mm (294 mm²). Assuming speaker 100 is provided with similar dimensions, necessitating no redesign of the surface footprint of the speaker in the cover of a laptop computer. In this case, the typical tweeter may have a height of 4.3 mm, and a total dimensional volume of 1.2 mm³, while speaker 100 may have a height of 3.2 mm, and a total dimensional volume of 0.76 mm³, a reduction of 37% of the dimensional volume.

However, it has been further understood that speaker 100 necessitates a smaller surface footprint on the laptop computer. For example, the typical tweeter may have an enclosure thickness of 0.8 mm and may need a surface of 0.3 mm in the top cover to permit the tweeter to be glued to the cover. Thus a tweeter with a 9 mm diaphragm would require a minimum box width of 11.2 mm (that is, 9 mm+2(0.8 mm+0.3 mm)). On the other hand, speaker 100 only needs 0.75 mm for attachment to the cover, requiring a minimum box width of 10.5 mm (that is, 9 mm+(0.75 mm+2(0.75 mm)), a reduction of 9 mm over the typical tweeter.

Further, speaker 100 manages the heat generated by the speaker better than the typical tweeter. In particular, the temperature of voice coil 140 is reduced in operation because the voice coil is surrounded by yoke 110 and washer element 160, and both the yoke and the washer element may be fabricated of metal, which has better thermal conductivity, as compared to the typical tweeter where the upper and lower covers are made of plastic. In particular, it was determined by the inventors of the current disclosure that the balanced temperature of speaker 100 may be up to 75° C. lower than the typical tweeter under a test arrangement where both the speaker and the typical tweeter were driven with continuous 2 W pink noise input, in free air condition. FIG. 1C illustrates where a sealed enclosed space (S) is formed by yoke 110, diaphragm 150 and washer element 160. Further, a magnetic gap (G) is formed between washer 130 and washer element 160. Because yoke 110 and washer element 160 are fabricated of magnetically conductive materials, the magnetic fields produced by magnet 120 and voice coil 140 are substantially contained within the yoke and the washer, thus improving the efficiency of speaker 100.

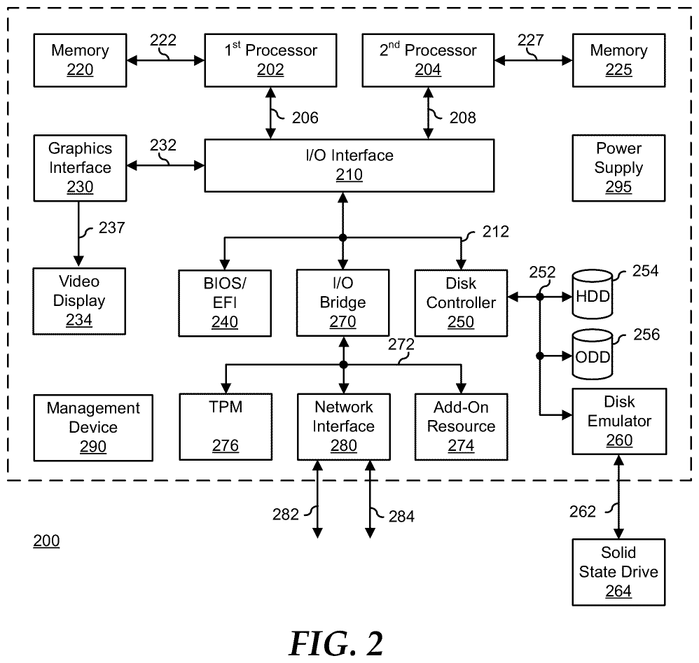

FIG. 2 illustrates a generalized embodiment of an information handling system 200 similar to information handling system 200. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 200 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 200 can include processing resources for executing machine-executable code, such as a central processing unit (CPU), a programmable logic array (PLA), an embedded device such as a System-on-a-Chip (SoC), or other control logic hardware. Information handling system 200 can also include one or more computer-readable medium for storing machine-executable code, such as software or data. Additional components of information handling system 200 can include one or more storage devices that can store machine-executable code, one or more communications ports for communicating with external devices, and various input and output (I/O) devices, such as a keyboard, a mouse, and a video display. Information handling system 200 can also include one or more buses operable to transmit information between the various hardware components.

Information handling system 200 can include devices or modules that embody one or more of the devices or modules described below, and operates to perform one or more of the methods described below. Information handling system 200 includes a processors 202 and 204, an input/output (I/O) interface 210, memories 220 and 225, a graphics interface 230, a basic input and output system/universal extensible firmware interface (BIOS/UEFI) module 240, a disk controller 250, a hard disk drive (HDD) 254, an optical disk drive (ODD) 256, a disk emulator 260 connected to an external solid state drive (SSD) 262, an I/O bridge 270, one or more add-on resources 274, a trusted platform module (TPM) 276, a network interface 280, a management device 290, and a power supply 295. Processors 202 and 204, I/O interface 210, memory 220, graphics interface 230, BIOS/UEFI module 240, disk controller 250, HDD 254, ODD 256, disk emulator 260, SSD 262, I/O bridge 270, add-on resources 274, TPM 276, and network interface 280 operate together to provide a host environment of information handling system 200 that operates to provide the data processing functionality of the information handling system. The host environment operates to execute machine-executable code, including platform BIOS/UEFI code, device firmware, operating system code, applications, programs, and the like, to perform the data processing tasks associated with information handling system 200.

In the host environment, processor 202 is connected to I/O interface 210 via processor interface 206, and processor 204 is connected to the I/O interface via processor interface 208. Memory 220 is connected to processor 202 via a memory interface 222. Memory 225 is connected to processor 204 via a memory interface 227. Graphics interface 230 is connected to I/O interface 210 via a graphics interface 232, and provides a video display output 236 to a video display 234. In a particular embodiment, information handling system 200 includes separate memories that are dedicated to each of processors 202 and 204 via separate memory interfaces. An example of memories 220 and 230 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 240, disk controller 250, and I/O bridge 270 are connected to I/O interface 210 via an I/O channel 212. An example of I/O channel 212 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 210 can also include one or more other I/O interfaces, including an Industry Standard Architecture (ISA) interface, a Small Computer Serial Interface (SCSI) interface, an Inter-Integrated Circuit (1²C) interface, a System Packet Interface (SPI), a Universal Serial Bus (USB), another interface, or a combination thereof. BIOS/UEFI module 240 includes BIOS/UEFI code operable to detect resources within information handling system 200, to provide drivers for the resources, initialize the resources, and access the resources. BIOS/UEFI module 240 includes code that operates to detect resources within information handling system 200, to provide drivers for the resources, to initialize the resources, and to access the resources.

Disk controller 250 includes a disk interface 252 that connects the disk controller to HDD 254, to ODD 256, and to disk emulator 260. An example of disk interface 252 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 260 permits SSD 264 to be connected to information handling system 200 via an external interface 262. An example of external interface 262 includes a USB interface, an IEEE 1394 (Firewire) interface, a proprietary interface, or a combination thereof. Alternatively, solid-state drive 264 can be disposed within information handling system 200.

I/O bridge 270 includes a peripheral interface 272 that connects the I/O bridge to add-on resource 274, to TPM 276, and to network interface 280. Peripheral interface 272 can be the same type of interface as I/O channel 212, or can be a different type of interface. As such, I/O bridge 270 extends the capacity of I/O channel 212 where peripheral interface 272 and the I/O channel are of the same type, and the I/O bridge translates information from a format suitable to the I/O channel to a format suitable to the peripheral channel 272 where they are of a different type. Add-on resource 274 can include a data storage system, an additional graphics interface, a network interface card (NIC), a sound/video processing card, another add-on resource, or a combination thereof. Add-on resource 274 can be on a main circuit board, on separate circuit board or add-in card disposed within information handling system 200, a device that is external to the information handling system, or a combination thereof.

Network interface 280 represents a NIC disposed within information handling system 200, on a main circuit board of the information handling system, integrated onto another component such as I/O interface 210, in another suitable location, or a combination thereof. Network interface device 280 includes network channels 282 and 284 that provide interfaces to devices that are external to information handling system 200. In a particular embodiment, network channels 282 and 284 are of a different type than peripheral channel 272 and network interface 280 translates information from a format suitable to the peripheral channel to a format suitable to external devices. An example of network channels 282 and 284 includes InfiniBand channels, Fibre Channel channels, Gigabit Ethernet channels, proprietary channel architectures, or a combination thereof. Network channels 282 and 284 can be connected to external network resources (not illustrated). The network resource can include another information handling system, a data storage system, another network, a grid management system, another suitable resource, or a combination thereof.

Management device 290 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 200. In particular, management device 290 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 200, such as system cooling fans and power supplies. Management device 290 can include a network connection to an external management system, and the management device can communicate with the management system to report status information for information handling system 200, to receive BIOS/UEFI or system firmware updates, or to perform other task for managing and controlling the operation of information handling system 200. Management device 290 can operate off of a separate power plane from the components of the host environment so that the management device receives power to manage information handling system 200 where the information handling system is otherwise shut down. An example of management device 290 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 290 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A speaker for a mobile device, the speaker comprising:
a bottom cover formed of a first metallic material;
a sound-producing diaphragm; and
a top cover formed of a second metallic material and to which the diaphragm is affixed, wherein the top cover is sealed to the bottom cover.

2. The speaker of claim 1, further comprising a permanent magnet affixed to a top surface of the bottom cover.

3. The speaker of claim 2, wherein the first metallic material is a first magnetically conductive material and the second metallic material is a second magnetically conductive material.

4. The speaker of claim 3, wherein a magnetic field produced by the magnet is substantially contained within the bottom cover and the top cover.

5. The speaker of claim 2, further comprising a washer affixed atop the magnet.

6. The speaker of claim 5, further comprising a voice coil affixed to the diaphragm.

7. The speaker of claim 6, wherein the voice coil surrounds the magnet.

8. The speaker of claim 1, wherein the speaker has a depth of less than 3.3 millimeters.

9. The speaker of claim 1, wherein the speaker has a dimensional volume of less than 0.77 cubic millimeters.

10. A method for providing a speaker in a mobile device, the method comprising:
providing the speaker with a bottom cover formed of a first metallic material;
providing the speaker with a sound-producing diaphragm;
providing the speaker with a top cover formed of a second metallic material;
affixing the diaphragm to the top cover; and
sealing the top cover to the bottom cover.

11. The method of claim 10, further comprising affixing a permanent magnet to a top surface of the bottom cover.

12. The method of claim 11, wherein the first metallic material is a first magnetically conductive material and the second metallic material is a second magnetically conductive material.

13. The method of claim 12, wherein a magnetic field produced by the magnet is substantially contained within the bottom cover and the top cover.

14. The method of claim 11, further comprising affixing a washer atop the magnet.

15. The method of claim 14, further comprising affixing a voice coil to the diaphragm.

16. The method of claim 15, wherein the voice coil surrounds the magnet.

17. The method of claim 10, wherein the speaker has a depth of less than 3.3 millimeters.

18. The method of claim 10, wherein the speaker has a dimensional volume of less than 0.77 cubic millimeters.

19. An information handling system, comprising:
a case; and
a speaker affixed within the case, wherein the speaker includes a bottom cover formed of a first metallic material, a sound-producing diaphragm, and a top cover formed of a second metallic material and to which the diaphragm is affixed, wherein the top cover is sealed to the bottom cover.

20. The information handling system of claim 19, wherein the speaker has a depth of less than 3.3 millimeters.
